(19) United States
(12) Patent Application Publication
(10) Pub. No.: US 2012/0227997 A1
(43) Pub. Date: Sep. 13, 2012

(54) MEDIUM-OR HIGH-VOLTAGE ELECTRIC CABLE

(76) Inventor: Christian Koelblin, Meximieux (FR)

(21) Appl. No.: 13/496,557

(22) PCT Filed: Sep. 29, 2010
(86) PCT No.: PCT/FR10/52050

§ 371 Date: May 29, 2012

(30) Foreign Application Priority Data
Sep. 30, 2009 (FR) 0956773

(51) Int. Cl. H01B 7/28

(52) U.S. Cl. 174/102 SC

(57) ABSTRACT

The present invention relates to an electric cable (1) comprising an electrical conductor (2), a first semiconducting layer (3) surrounding the electrical conductor (2), an electrically insulating layer (4), obtained from an electrically insulating composition, surrounding the first semiconducting layer (3), and a second semiconducting layer (5) surrounding the electrically insulating layer (4), characterized in that at least one of the semiconducting layers (3, 5) is obtained from a semiconducting composition comprising an ethylene homopolymer, a nonpolar ethylene copolymer and a semiconducting filler in an amount sufficient to render the composition semiconducting.

The present invention relates to an electric cable exhibiting an improved resistance to ageing in a humid environment under electric voltage.

It typically but not exclusively applies to the fields of medium-voltage power cables (in particular from 6 to 45-60 kV) or to high-voltage power cables (in particular of greater than 60 kV and which can range up to 500-600 kV), whether they are direct current or alternating current cables.

Medium- and high-voltage power cables may be in contact with surrounding moisture during their lifetime. The presence of moisture in combination with the presence of an electric field and of a polymer material favor the gradual deterioration in the insulating properties of the cable.

This decomposition mechanism, well known under the term “water tree growth”, can thus lead to the breakdown of the cable concerned and thus constitutes a considerable threat with regard to the reliability of the power transmission network with well-known economic consequences brought about by current failures.

The document EP-1 148 518 describes a medium-voltage power cable comprising a first semiconducting layer covered with an electrically insulating layer and a second semiconducting layer covering the electrically insulating layer, thus forming a three-layer insulation. The electrically insulating layer, which is extruded and crosslinked, is obtained from an electrically insulating composition comprising a low density ethylene homopolymer (80 parts by weight) and a polar ethylene copolymer (20 parts by weight) as water tree retardant compound (or WTR compoumd). This polar ethylene copolymer is of the following types: copolymer of ethylene and of vinyl acetate (EVA), copolymer of ethylene and of butyl acrylate (EBA), copolymer of ethylene and of ethyl acrylate (EEA) or copolymer of ethylene and of methyl acrylate (EMA).

However, even if this composition makes it possible to reduce water trees for electrically insulating layers, they constitute only a part of the three-layer insulation, all the components of which have a significant effect on the birth and the growth of water trees. Research undertaken in the past has resulted in numerous electrically insulating compositions which retard the birth and growth of water trees. Given this, the influence of the semiconducting layers on the birth and growth of water trees has not really been studied and, for this reason, the semiconducting layers are not today optimized to limit the deterioration related to these water trees.

The aim of the present invention is to overcome the disadvantages of the techniques of the prior art by providing a novel composition intended to be used as semiconducting layer for an electric cable which exhibits a significantly improved resistance to aging in a wet environment in the presence of an electric field.

A subject matter of the present invention is an electric cable comprising an electrical conductor, a first semiconducting layer surrounding the electrical conductor, an electrically insulating layer, obtained from an electrically insulating composition, surrounding the first semiconducting layer, and a second semiconducting layer surrounding the electrically insulating layer, characterized in that at least one of the semiconducting layers is obtained from a semiconducting composition comprising an ethylene homopolymer, a nonpolar ethylene copolymer and a semiconducting filler in an amount sufficient to render the composition semiconducting. Preferably, the first and the second semiconducting layers are obtained from said semiconducting composition, the semiconducting filler having the following properties:
the BET specific surface according to standard ASTM D 6556 is strictly less than 500 m²/g and preferably strictly less than 350 m²/g, and
the oil absorption value according to standard ASTM D 2414-90 is strictly less than 200 ml/100 g and preferably strictly less than 174 ml/100 g.

It has been discovered, surprisingly, that the use of a nonpolar ethylene copolymer, as replacement for the compounds which limit water trees conventionally used in the prior art, makes it possible to effectively limit the deterioration related to water trees in compositions comprising semiconducting fillers.

This is because the mixture of a polar ethylene copolymer with a semiconducting filler is not really suitable for this type of application (i.e., semiconducting composition) since a gradual significant deterioration in the electrically insulating properties of the cable related to water trees has been observed with this type of mixture.

In addition, the advantage of using this type of semiconducting filler is that it has a structure which allows it to facilitate the dispersion thereof in the composition of the invention and thus to guarantee optimum conductivity properties as a result of its more rigid structure in comparison with that of “high structure” semiconducting fillers having a specific surface of more than 500 m²/g.

Finally, the retraction properties of the crosslinked compositions related to the nature of the semiconducting fillers of the invention are advantageously optimized in order to contribute to a good dimensional stability of the cable.

The term “semiconducting” used in the present invention should be also understood as meaning “conducting”.

“Nonpolar” is understood to mean any ethylene copolymer not comprising polar functional groups, such as acetate, acrylate, hydroxyl, nitrile, carboxyl or carbonyl groups or any other group having a polar nature well known in the prior art. This excludes in particular from the context of the invention ethylene copolymers of the following types: copolymers of ethylene and vinyl acetate (EVA), copolymers of ethylene and butyl acrylate (EBA), copolymers of ethylene and ethyl acrylate (EEA), copolymers of ethylene and methyl acrylate (EMA) or copolymers of ethylene and acrylic acid (EAA).

The ethylene homopolymer in accordance with the invention can be chosen from a low density polyethylene (LDPE), a linear low density polyethylene (LLDPE) and a very low density polyethylene (VLDPE), or one of their blends.

More particularly, it is preferable to use a low density polyethylene (LDPE) since it exhibits very good processing properties, in particular by extrusion.

Typically, the low density polyethylene (LDPE) can be obtained by a polymerization process in a high pressure tubular reactor or in an autoclave reactor.

“Low density” is understood to mean a density which can range from 0.910 to 0.940 g/cm³ and preferably which can range from 0.910 to 0.930 g/cm³, according to standard ISO 1183 (at a temperature of 23° C.).

“Very low density” is understood to mean a density which can range from 0.860 to 0.910 g/cm³ according to standard ISO 1183 (at a temperature of 23° C.).

The ethylene homopolymer of the invention preferably has an MFI (Melt Flow Index), determined according to standard ISO 1133, of greater than 5 g/10 min at 190° C. and 2.16 kg and preferably of greater than 7 g/10 min at 190° C. and 2.16 kg, in order to facilitate the processing of the composition, in particular to facilitate the extrusion thereof, and to be able to incorporate therein a large amount of semiconducting filler, that is to say an amount which can be greater than 25% by weight of semiconducting filler in the composition.

The nonpolar ethylene copolymer in accordance with the invention can comprise a comonomer of α-olefin type, in particular C₃-C₁₂ α-olefin type. Preferably, the comonomer of α-olefin type can be chosen from propylene, 4-methyl-1-pentene, 1-butene, 1-hexene or 1-octene. It will be preferable to use, as α-olefin, 1-octene in order to form the copolymer of ethylene and octene (PEO).

In addition, the nonpolar ethylene copolymer can comprise a comonomer of diene type. The comonomer of diene type can be chosen from ethylidenenorbornene, dicyclopentadiene, vinylnorbornene and 1,4-hexadiene. This type of ethylene copolymer can in particular be an ethylene/propylene terpolymer, such as, for example, the copolymer of ethylene, propylene and diene (EPDM).

Typically, the nonpolar ethylene copolymer is obtained from the copolymerization of ethylene with said α-olefin in the presence of a Ziegler-Natta catalyst, of a metal oxide catalyst or of a single-site catalyst.

It will be preferable to use a single-site catalyst, such as, for example, a metallocene catalyst well known to a person skilled in the art. A copolymer obtained by this type of copolymerization is commonly known as a metallocene copolymer.

“Metallocene” nonpolar ethylene copolymers have more uniform molecular structures (i.e., having a “narrow” molecular weight distribution, also referred to as “low polydispersity” polymer) which confers excellent mechanical properties on them, in particular an excellent elongation at break, even in the presence of high contents of fillers.

In addition, they have a higher degree of purity with respect to the catalyst residues occurring in the copolymer after the manufacture thereof, compared with the nonpolar ethylene copolymers obtained by polymerization processes using catalysts of Ziegler-Natta or metal oxide type.

Thus, metallocene nonpolar ethylene copolymers exhibit better resistance to thermal decomposition (i.e., thermal stress) and to environmental stress cracking resistance (ESCR) than nonpolar ethylene copolymers with a substantially identical degree of crystallinity obtained by a different copolymerization process.

In a specific embodiment, the semiconducting composition comprises at least 50 parts by weight of ethylene homopolymer per 100 parts of polymer(s) (i.e., polymer matrix) in said composition, preferably at least 70 parts by weight of ethylene homopolymer per 100 parts of polymer(s) in said composition, and particularly preferably at least 75 parts by weight of ethylene homopolymer per 100 parts of polymer(s) in said composition.

In addition, it is preferable for the semiconducting composition not to comprise more than 85 parts by weight of ethylene homopolymer per 100 parts of polymer(s) in said composition.

In another specific embodiment, the semiconducting composition comprises at least 15 parts by weight of nonpolar ethylene copolymer per 100 parts by weight of polymer(s) (i.e., polymer matrix) in said composition and preferably at least 25 parts by weight of nonpolar ethylene copolymer per 100 parts by weight of polymer(s) in said composition.

The lower limit of 15 parts by weight makes it possible to advantageously retain the mechanical properties of the semiconducting layer: below 15 parts by weight of nonpolar ethylene copolymer, the elongation at break of the semiconducting layer may fall and thus become insufficient for application in medium- and high-voltage power cables.

In addition, it is preferable for the semiconducting composition not to comprise more than 30 parts by weight of nonpolar ethylene copolymer per 100 parts by weight of polymer(s) in said composition, in order to facilitate the processing of the composition.

Typically, the ratio of the percentage by weight of ethylene homopolymer to the percentage by weight of ethylene copolymer in the semiconducting composition is preferably greater than 1 in order to obtain a predominant phase of ethylene homopolymer and a minor phase of nonpolar ethylene copolymer.

Particularly preferably, the polymers of which the semiconducting composition of the invention is composed are solely one or more ethylene homopolymers and one or more nonpolar ethylene copolymers.

The semiconducting filler is added to the semiconducting composition in order to render the latter semiconducting. In general, this composition can comprise from 4 to 40% by weight of semiconducting filler, preferably at least 15% by weight of semiconducting filler and more preferably still at least 25% by weight of semiconducting filler.

The semiconducting filler can advantageously be chosen from carbon blacks and graphites, or one of their mixtures.

Carbon blacks are more particularly preferred and can have the following physical characteristics:
an oil (di(n-butyl)phthalate) absorption value, according to standard ASTM D 2414-90, of at least 100 cm³/100 g, and
a BET specific surface value, according to standard ASTM D 6556, of at least 40 m²/g.

In addition, use may be made of carbon blacks having a high degree of purity.

A high degree of purity can be expressed by a sulfur content of less than 1% by weight, preferably of less than 0.5% by weight and particularly preferably of less than 0.25% by weight in the carbon black under consideration, this degree of purity being conventionally determined by the measurement method according to standard ASTM D-1619.

It can also be expressed by an ash content of less than 2% by weight, preferably of less than 1% by weight and particularly preferably of less than 0.5% by weight in the carbon black under consideration, this ash content being conventionally determined by the measurement method according to standard ASTM D-1506.

The semiconducting composition according to the invention can additionally comprise at least one protective agent, such as an antioxidant. Antioxidants make it possible to protect the composition from the thermal stress generated during the stages of manufacture of the cable or of operation of the cable.

The antioxidants are preferably chosen from:
sterically hindered phenolic antioxidants, such as tetrakis[methylene(3,5-di(t-butyl)-4-hydroxyhydro-cinnamate)]methane, octadecyl 3-(3,5-di(t-butyl)-4-hydroxyphenyl)propionate, 2,2′-thiodiethylenebis[3-(3,5-di(t-butyl)-4-hydroxyphenyl)propionate], 2,2′-thiobis(6-(t-butyl)-4-methylphenol), 2,2′-methylenebis(6-(t-butyl)-4-methylphenol), 1,2-bis(3,5-di(t-butyl)-4-hydroxyhydrocinnamoyl)-hydrazine, 2,2′-oxamidodiethyl bis[3-(3,5-di(t-butyl)-4-hydroxyphenyl)propionate] and 2,2′-oxamidodiethyl bis[3-(t-butyl)-4-hydroxyphenyl)propionate];
thioethers, such as 4,6-bis(octylthiomethyl)-o-cresol, bis[2-methyl-4-{3-(n-(C₁₂ or C₁₄)alkylthio)-propionyloxy}-5-(t-butyl)phenyl]sulfide and thiobis[2-(t-butyl)-5-methyl-4,1-phenylene]bis[3-(dodecylthio)propionate];
sulfur-based antioxidants, such as dioctadecyl 3,3′-thiodipropionate or didodecyl 3,3′-thiodipropionate;
phosphorus-based antioxidants, such as phosphites or phosphonates, such as, for example, tris[2,4-di(t-butyl)phenyl]phosphite or bis[2,4-di(t-butyl)phenyl]pentaerythritol diphosphite; and
amine-type antioxidants, such as polymerized 2,2,4-trimethyl-1,2-dihydroquinoline (TMQ), the latter type of antioxidant being particularly preferred in the composition of the invention.

The TMQs can have different grades, namely:
a “standard” grade with a low degree of polymerization, that is to say with a residual monomer content of greater than 1% by weight and having residual NaCl content which can range from 100 ppm to more than 800 ppm (parts per million by weight);
a “high degree of polymerization” grade with a high degree of polymerization, that is to say with a residual monomer content of less than 1% by weight and having a residual NaCl content which can range from 100 ppm to more than 800 ppm;
a “low content of residual salt” grade with a residual NaCl content of less than 100 ppm.

The type of stabilizing agent and its content in the semiconducting composition are conventionally chosen according to the maximum temperature to which the polymers are subjected during the production of the mixture and during the processing by extrusion over the cable, and also according to the maximum duration of exposure to this temperature.

The semiconducting composition can typically comprise from 0.3 to 2% by weight of antioxidant(s). Preferably, it can comprise at most 0.7% by weight of antioxidant(s), in particular when the antioxidant is TMQ.

Other additives can also be added to the semiconducting composition of the invention, such as scorch retardants, crosslinking coagents, processing aids, such as lubricants or waxes, compatibilizing agents, coupling agents, UV stabilizers and nonconducting fillers.

The electrically insulating layer of the invention can be obtained from an electrically insulating composition comprising at least 50 parts by weight of ethylene homopolymer per 100 parts by weight of polymer(s) (i.e., polymer matrix) in said composition, preferably at least 75 parts by weight of ethylene homopolymer per 100 parts by weight of polymer(s) in said composition.

The ethylene homopolymer can be chosen from a low density polyethylene (LDPE), a linear low density polyethylene (LLDPE) and a very low density polyethylene (VLDPE), or one of their blends.

The electrically insulating composition can additionally comprise a compound which limits water trees. The latter can be a polar ethylene copolymer and, as such, can thus form part of the polymer matrix.

According to a specific embodiment, the electrically insulating layer of the electric cable is obtained from an electrically insulating composition not comprising a compound which limits water trees.

By way of example, the electrically insulating composition comprises an ethylene homopolymer as sole polymer in said composition. Thus, the polymer matrix of which the electrically insulating composition is composed thus does not comprise a polar ethylene copolymer which is a compound which limits water trees. In other words, the electrically insulating composition comprises 100 parts by weight of ethylene polymer and 100 parts by weight of polymer(s) in the electrically insulating composition.

Consequently, the preparation of this electrically insulating composition does not require additional stages of mixing between at least two polymers, as is required by the electrically insulating composition of the blend between the low-density ethylene homopolymer and the polar ethylene copolymer of the document EP-1 148 518.

It may be added that the fact of having a single type of polymer (solely an ethylene homopolymer) in the electrically insulating layer makes it possible to significantly limit the dielectric losses throughout the lifetime of the electric cable.

The electrically insulating layer of the cable of the invention can additionally comprise at least one protective agent, such as those mentioned for the semiconducting layer(s). In addition, it can comprise other additives, such as those mentioned for the semiconducting layer(s).

Whether these are the first semiconducting layer, the electrically insulating layer and/or the second semiconducting layer, at least one of these layers is an extruded layer, preferably two of these three layers are extruded layers and more preferably still these three layers are extruded layers.

In the same way, at least one of these three layers is a crosslinked layer, preferably two of these three layers are crosslinked layers and more preferably still these three layers are crosslinked layers.

Consequently, the semiconducting composition of the invention, as well as the electrically insulating composition, can be crosslinked.

The crosslinking at least of one of these compositions (i.e., semiconducting composition and/or electrically insulating composition) can be carried out by conventional crosslinking techniques well known to a person skilled in the art such as, for example, peroxide crosslinking and/or hydrosilylation under the action of heat; silane crosslinking in the presence of a crosslinking agent; crosslinking by electron beams, gamma rays, X-rays or microwaves; crosslinking by the photochemical route, such as irradiation under β radiation or irradiation under ultraviolet radiation in the presence of a photoinitiator.

The peroxide crosslinking under the action of heat is preferred in the context of the invention. In this specific case, the composition taken into consideration (cf. semiconducting composition and/or electrically insulating composition) additionally comprises a crosslinking agent, such as an organic peroxide.

Examples of organic peroxides which are well known to a person skilled in the art can be used, such as, for example, dicumyl peroxide, t-butyl cumyl peroxide, 2,5-dimethyl-2,5-di(t-butylperoxy)hexane, di(t-buty) peroxide or di(2-(t-butylperoxy)isopropyl)benzene.

In a specific embodiment, generally in accordance with the electric cable well known in the field of application of the invention, the first semiconducting layer, the electrically insulating layer and the second semiconducting layer constitute a three-layer insulation. In other words, the electrically insulating layer is directly in physical contact with the first semiconducting layer and the second semiconducting layer is directly in physical contact with the electrically insulating layer.

The electric cable of the invention can additionally comprise a metallic shield surrounding the second semiconducting layer.

This metallic shield can be a “wire” shield composed of an assembly of conductors made of copper or aluminum arranged around and along the second semiconducting layer, a “strip” shield composed of one or more conducting metal strips positioned helically around the second semiconducting layer, or a “leaktight” shield of metal tube type surrounding the second semiconducting layer. The latter type of shield makes it possible in particular to form a barrier to the moisture which has a tendency to penetrate the electric cable in a radial direction.

All these types of metallic shields can play the role of earthing the electric cable and can thus transmit fault currents, for example in the event of short-circuit in the network concerned.

In addition, the electric cable of the invention can comprise an external protective sheath surrounding the second semiconducting layer or else more particularly surrounding said metallic shield, when it exists. This external protective sheath can be made conventionally from appropriate thermoplastic materials, such as HDPEs, MDPEs or LLDPEs; or also materials which can retard flame propagation or withstand flame propagation. In particular, if the latter materials do not comprise halogen, reference is made to sheathing of HFFR (Halogen-Free Flame Retardant) type.

Other layers, such as layers which expand in the presence of moisture, can be added between the second semiconducting layer and the metallic shield, when it exists, and/or between the metallic shield and the external sheath, when they exist, these layers making it possible to ensure the longitudinal leaktightness toward water of the electric cable. The electrical conductor of the cable of the invention can also comprise materials which expand in the presence of moisture in order to obtain a “leaktight core”.

Another subject matter according to the invention relates to a process for the manufacture of an electric cable as described above comprising three successive layers. This process comprises the stages consisting in:
i. extruding and depositing the first semiconducting layer around the electrical conductor,
ii. extruding and depositing the electrically insulating layer around said first layer,
iii. extruding and depositing the second semiconducting layer around said electrically insulating layer, and
iv. crosslinking the first, second and third layers.

In an alternative form, stages i to iii can be carried out concomitantly, stage iv being carried out after the coextrusion and the codeposition of the first semiconducting layer, of the electrically insulating layer and of the second semiconducting layer.

In another alternative form, stage iv can be carried out after each of stages i, ii and iii.

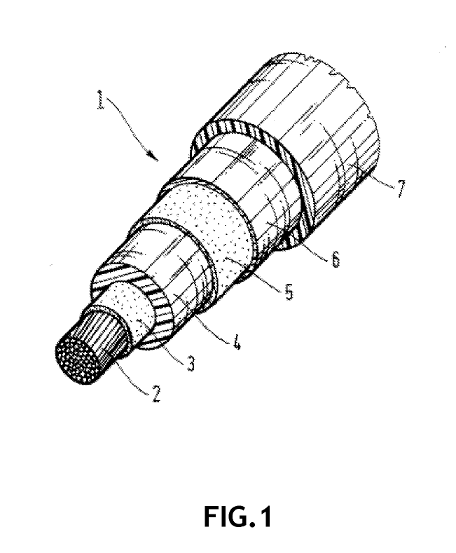

Other characteristics and advantages of the present invention will become apparent in the light of the description of a nonlimiting example of an electric cable according to the invention made with reference to FIG. 1, which represents a diagrammatic view in perspective and in cross section of an electric cable according to a preferred embodiment in accordance with the invention.

For reasons of clarity, only the components essential for the understanding of the invention have been represented diagrammatically and without respecting the scale.

The medium- or high-voltage power cable 1, illustrated in FIG. 1, comprises a central conducting component 2, in particular made of copper or aluminum, and, successively and coaxially, comprises, around this component, a first semiconducting layer 3 referred to as “inner semiconducting layer”, an electrically insulating layer 4, a second semiconducting layer 5 referred to as “outer semiconducting layer”, a metallic shield 6 of the cylindrical tube type and an external protective sheath 7, the semiconducting layers 3 and 5 being obtained from a composition according to the invention.

The layers 3, 4 and 5 are layers extruded and crosslinked by processes well known to a person skilled in the art.

The presence of the metallic shield 6 and of the external protective sheath 7 is preferable but not essential. This cable structure is as such of known type and outside the scope of the present invention.

### EXAMPLES

### Manufacture of an Electric Cable Comprising a Three-Layer Insulation

The materials used to prepare the various layers of the three-layer insulation of electric cables denoted Cc (comparative cable) or Ci (cable of the invention) are referenced in the following table 1.

The “Semiconducting layer 1” of table 1 corresponds to the inner semiconducting layer (e.g., reference 3 in FIG. 1), while the “Semiconducting layer 2” of table 1 corresponds to the outer semiconducting layer (e.g., reference 5 in FIG. 1).

TABLE 1

| Cable Cc or Ci: | | | |
|---|---|---|---|
| composition of | Semi- | Electrically | Semi- |
| the three-layer | conducting | insulating | conducting |
| insulation | layer 1 | layer | layer 2 |
| Cc1 | LE | LH | LE |
| Cc2 | R1 | HF_ei3 | R1 |
| Cc3 | HF_sc | HF_ei3 | HF_sc |
| Ci1 | EB1 | HF_ei3 | EB1 |
| Ci2 | EB2 | HF_ei3 | EB2 |
| Ci3 | EB3 | HF_ei3 | EB3 |
| Ci4 | EB4 | HF_ei3 | EB4 |
| Ci5 | EB5 | HF_ei3 | EB5 |
| Ci6 | EB6 | HF_ei3 | EB6 |
| Ci7 | EB1 | LH | EB1 |
| Ci8 | EB7 | HF_ei3 | EB7 |
| Ci9 | EB8 | HF_ei3 | EB8 |

Table 2 below describes in detail the compositions used to obtain the semiconducting layers referenced in table 1. These compositions are all crosslinkable and comprise an organic peroxide for this purpose. In addition, they comprise a semiconducting filler and an antioxidant.

TABLE 2

| | |
|---|---|
| LE | Semiconducting composition based on a polar |
| | ethylene copolymer of EBA type and having a |
| | content of carbon black of approximately 38% |
| | by weight, sold by Borealis under the reference |
| | LE0592 |
| R1 | Semiconducting composition comprising 67.4% |
| | by weight of Clearflex MPDO, 32% by weight of |
| | Vulcan XC-500 and 0.6% by weight of antioxidant |
| | (TMQ) |
| HF_sc | Semiconducting composition based on a polar |
| | ethylene copolymer of EEA type and having a |
| | content of carbon black of approximately 32% |
| | by weight, sold by Dow under the reference |
| | HFDK-0586-BK |
| EB1 | Semiconducting composition comprising 69.4% |
| | by weight of a blend of 75 parts by weight of |
| | Riblene MP20 and 25 parts by weight of Exact |
| | 8203, 30% by weight of Vulcan XC-500 and 0.6% |
| | by weight of TMQ1 |
| EB2 | Semiconducting composition comprising 69.4% |
| | by weight of a blend of 75 parts by weight of |
| | LDPE 1808AN00 and 25 parts by weight of |
| | Engage 8450, 30% by weight of Vulcan XC-500 |
| | and 0.6% by weight of TMQ2 |
| EB3 | Semiconducting composition comprising 69.4% |
| | by weight of a blend of 75 parts by weight of |
| | Riblene MP20 and 25 parts by weight of Exact |
| | 8203, 30% by weight of Vulcan XC-500 and 0.6% |
| | by weight of TMQ2 |
| EB4 | Semiconducting composition comprising 69.4% |
| | by weight of a blend of 50 parts by weight of |
| | Clearflex MPD0 and 50 parts by weight of |
| | Riblene MP20, 30% by weight of Vulcan XC-500 |
| | and 0.6% by weight of TMQ2 |
| EB5 | Semiconducting composition comprising 69.4% |
| | by weight of a blend of 75 parts by weight of |
| | Riblene MP20 and 25 parts by weight of Exact |
| | 8203, 30% by weight of Conductex 7055 Ultra |
| | and 0.6% by weight of TMQ1 |
| EB6 | Semiconducting composition comprising 69.4% |
| | by weight of a blend of 75 parts by weight of |
| | Novex 19N430 and 25 parts by weight of Exact |
| | 8203, 30% by weight of Vulcan XC-500 and 0.6% |
| | by weight of TMQ3 |
| EB7 | Semiconducting composition comprising 69.4% |
| | by weight of a blend of 75 parts by weight of |
| | LDPE 2008TN00 and 25 parts by weight of Exact |
| | 8203, 30% by weight of Vulcan XC-500 and 0.6% |
| | by weight of TMQ1 |
| EB8 | Semiconducting composition comprising 61.4% |
| | by weight of a blend of 70 parts by weight of |
| | LDPE 2015T and 30 parts by weight of Exact |
| | 8203, 38% by weight of Purex HS 45 and 0.6% |
| | by weight of TMQ1 |

In table 2 above:
“Clearflex MPDO” is a commercial reference of Polimeri Europa SpA for a nonpolar copolymer of ethylene and α-olefin referred to as VLDPE (Very Low Density Polyethylene), the density of which is 0.900 g/cm³ and the MFI of which is 7.5 g/10 min;
“Riblene MP20” is a commercial reference of Polimeri Europa SpA for a low density ethylene homopolymer obtained by a polymerization process in an autoclave reactor at high pressure, the density of which is 0.919 g/cm³ and the MFI of which is 7.5 g/10 min;
“LDPE 1808AN00” is a commercial reference of Sabic Europe B.V. for a low density ethylene homopolymer obtained by a polymerization process in an autoclave reactor at high pressure, the density of which is 0.920 g/cm³ and the MFI of which is 7.5 g/10 min;
“Novex 19N430” is a commercial reference of Ineos O&P Europe for a low density ethylene homopolymer obtained by a polymerization process in an autoclave reactor at high pressure, the density of which is 0.920 g/cm³ and the MFI of which is 7.5 g/10 min;
“LDPE 2008TN00” is a commercial reference of Sabic Europe B.V. for a low density ethylene homopolymer obtained by a polymerization process in a tubular reactor at high pressure, the density of which is 0.921 g/cm³ and the MFI of which is 7.5 g/10 min;
“LDPE 2015 T” is a commercial reference of Sabic Europe B.V. for a low density ethylene homopolymer obtained by a polymerization process in a tubular reactor at high pressure, the density of which is 0.920 g/cm³ and the MFI of which is 15 g/10 min;
“Engage 8450” is a commercial reference of the Dow Chemical Company for a nonpolar copolymer of ethylene and octene resulting from a polymerization process with a metallocene catalyst, the density of this copolymer being 0.902 g/cm³;
“Exact 8203” is a commercial reference of Dex Plastomers for a nonpolar copolymer of ethylene and octene resulting from a polymerization process with a metallocene catalyst, the density of this copolymer being 0.882 g/cm³;
“Vulcan XC-500” is a commercial reference of Cabot Corporation for a conducting carbon black having a BET specific surface according to standard ASTM D 6556 of 58 m²/g, an oil absorption according to standard ASTM D 2414-90 of 150 ml/100 g, a sulfur content of less than 0.1% by weight and an ash content of less than 0.1% by weight;
“Conductex 7055 Ultra” is a commercial reference of Columbian Chemicals Company for a conducting carbon black having a BET specific surface according to standard ASTM D 6556 of 55 m²/g, an oil absorption according to standard ASTM D 2414-90 of 170 ml/100 g, a sulfur content of less than 0.5% by weight and an ash content of less than 0.075% by weight;
“Purex HS 45” is a commercial reference of Evonik Carbon Black for a carbon black of “improved N550” type having a BET specific surface according to standard ASTM D 6556 of 41 m²/g, an oil absorption according to standard ASTM D 2414-90 of 121 ml/100 g, a sulfur content of less than 0.5% by weight and an ash content of less than 0.35% by weight;
“TMQ1” is an antioxidant of the “low content of residual salt” 2,2,4-trimethyl-1,2-dihydroquinoline type, sold by Lanxess Deutschland GmbH under the reference Vulkanox HS/LG “low salt”;
“TMQ2” is an antioxidant of the “standard” 2,2,4-trimethyl-1,2-dihydroquinoline type, sold by Lanxess Deutschland GmbH under the reference Vulkanox HS/LG; and
“TMQ3” is an antioxidant of the “high degree of polymerization” 2,2,4-trimethyl-1,2-dihydroquinoline type, sold by Songwon Industrial Co. Ltd. under the reference Antioxidant FR SB.

Table 3 below describes in detail the compositions used to obtain the electrically insulating layers referenced in table 1. These compositions are all crosslinkable and comprise an organic peroxide for this purpose. In addition, they comprise an antioxidant.

TABLE 3

| | |
|---|---|
| LH | Electrically insulating composition based on |
| | the blend of an ethylene homopolymer and a |
| | polar ethylene copolymer sold by Borealis |
| | under the reference LH4201/R |
| HF_ei3 | Electrically insulating composition |
| | comprising a polymer matrix solely based on |
| | an ethylene homopolymer, sold by Dow under |
| | the reference HFDK 4201 EC |

All of the constituents of the compositions R1 and EB1 to EB8 referenced in table 2, for each layer to be considered, are respectively metered into and mixed in a continuous mixer of Buss co-kneader type, twin-screw extruder type or another type of mixer appropriate for filler-comprising thermoplastic mixtures. The mixture is subsequently extruded in the form of rods and then cooled and dried in order to be formed into granules. These granules are then impregnated with a liquid organic peroxide, the content of which is adjusted according to the amount of polymer matrix to be crosslinked.

These impregnated granules are introduced into a single-screw extruder in order to extrude and to deposit each of said compounds around the copper electrical conductor, according to the type of layers and their positioning mentioned in table 1.

The compositions LE, HF_sc, LH and HF_ei3 referenced in tables 2 and 3 are ready-for-use compositions. Thus, for each layer to be considered, these compositions are introduced directly into a single-screw extruder in order to extrude and deposit each of said compositions around the copper electrical conductor, according to the type of layers and their positioning mentioned in table 1.

Thus, the various compositions are extruded one after the other in order to successively surround the copper electrical conductor and thus to form the various three-layer insulations as mentioned in table 1.

Finally, each three-layer insulation is crosslinked under the action of heat at a temperature greater than the decomposition temperature of the organic peroxide included in each of the three layers.

Thus, the electric cables Cc1 to Cc3 and Ci1 to Ci9, each comprising three extruded and crosslinked layers, are respectively obtained.

### Breakdown Voltage and Aging Test

In order to determine the properties of resistance to water trees of the electric cables Cc1 to Cc3 and Ci1 to Ci9, application is made of the method described in the document “Model Cable Test for Evaluating the Aging Behavior under Water Influence of Compounds for Medium Voltage Cables”, H.G. Land and Hans Schädlich, pages 177 to 182, published during the “Conference Proceedings of Jicable 91”, of 24-28 Jun. 1991, at Versailles, France. This method consists first of all in carrying out breakdown tests with an alternating voltage with a frequency of 50 Hz on “nonaged” samples (which have been subjected to conditioning at 90° C. for 16 hours in a non-humid environment) of electric cables Cc1 to Cc3 and Ci1 to Ci9, in order to determine the initial value of the breakdown voltage, and in subsequently carrying out these breakdown tests on “aged” samples of electric cables Cc1 to Cc3 and Ci1 to Ci9, placed under alternating voltage, in a tank of water heated at 70° C. for 1000 hours (according to the conditions referenced “Ageing 2” in said document) and in the presence of water heated at 85° C. between the conductor and the “Semiconducting layer 1”, in order to determine their breakdown voltage after 1000 h.

The breakdown voltage (in kV/mm) of the electric cable corresponds to the voltage necessary to form an electric arc in the cable. It is typically brought back to the maximum electric field at the interface between the first semiconducting layer (or inner semiconducting layer) and the electrically insulating layer of the electric cable.

The results for the breakdown voltages are collated in table 4 below.

TABLE 4

| | Initial value | After 1000 h |
|---|---|---|
| Cable | (kV/mm) | (kV/mm) |
| Cc1 | 133 | 55 |
| Cc2 | 107 | 41 |
| Cc3 | 97 | 40 |
| Ci1 | 95 | 65 |
| Ci2 | 108 | 57 |
| Ci3 | 100 | 57 |
| Ci4 | 103 | 54 |
| Ci5 | 120 | 50 |
| Ci6 | 109 | 47 |
| Ci7 | 100 | 81 |
| Ci8 | 117 | 47 |
| Ci9 | 87 | 45 |

It is noticed, in table 4, that the three-layer complexes of the cables Ci1 to Ci6 and also Ci8 and Ci9, composed:
of a polymer matrix predominantly comprising an ethylene homopolymer in combination with a nonpolar ethylene copolymer for the semiconducting layers, and
of a polymer matrix comprising solely an ethylene homopolymer (composition devoid of water tree retardant) for the electrically insulating layer,
   exhibit a breakdown voltage far above 40 kV/mm, in comparison with the three-layer complexes of the cables Cc2 and Cc3.

The three-layer complexes of these two cables both comprise an electrically insulating layer of the same nature as the three-layer complexes of the cables Ci1 to Ci6 and also Ci8 to Ci9, whereas their semiconducting layers are respectively composed of a nonpolar matrix (for the cable Cc2) and of a polar matrix (for the cable Cc3).

Thus, the combination of semiconducting layers according to the invention with an electrically insulating layer devoid of compound which limits water trees exhibits a very good resistance to aging and an improved resistance to water trees, while remaining very economic.

In addition, it may be noted that the three-layer complexes of the cable Ci7 exhibits properties of resistance to water trees after 1000 h (81 kV/mm) which are significantly better than those of the cables Cc1 (55 kV/mm), Cc2 (41 kV/mm) and Cc3 (40 kV/mm) and more particularly than those of the cable Cc1 which comprises, like the three-layer complexes of the cable Ci7, an electrically insulating layer based on an ethylene homopolymer in combination with a polar ethylene copolymer. This difference in results is due to the nature of the semiconducting layer of the three-layer complexes.

Even if the preparation of the electrically insulating layer of the three-layer complexes of the cable Ci7 includes different stages of mixing (between the polymers of which this layer is composed), the combination of this layer with a semiconducting layer according to the invention induces a synergistic effect of the most significant kind since the breakdown voltage is the highest in table 4 and reaches 80 kV/mm after aging for 1000 h.

### Retraction Test

The retraction test makes it possible to measure the ability of a plastic to retain a form which has been given to it by different forming techniques, such as extrusion, molding and others.

In the art of the manufacture of power cables, retraction tests have to be carried out as it is necessary to make sure that the materials constituting the cable retain good dimensional stability during the life of the cable. Without this dimensional stability, to be considered in particular in the longitudinal direction of the cable, that is to say in the direction of the conducing core over the entire length of the cable, defects may appear, in particular at the connecting points (joints and terminations), and bring about failure of the power cable. These tests are carried out on cable samples, for example according to standards IEC 60502-2 and IEC 60811-1-3, with regard to the electrically insulating layers made of crosslinked polyethylene of medium-voltage power cables for rated voltages of 1 to 30 kV. In addition, retraction tests are commonly carried out on the external protective sheaths of the cables.

This being the case, the retraction test was carried out in the laboratory by forming compression moldings.

To evaluate the retraction behavior of the semiconducting compositions described above, use is made of measurements on compression-molded plaques. The impression of the mold, which is composed of a base comprising this impression and of a smooth lid, has the following dimensions: width*depth*height=200 mm*200 mm*2 mm. It is a cored mold which makes it possible to discharge a possible surplus of material without having an impact on the dimensions of the molded plaque. An amount of material of the crosslinkable semiconducting composition which guarantees that the entire cavity is satisfactorily filled is introduced into the impression of the mold, which mold is not preheated and is coated beforehand with a thin film of polyester (thickness 50 μm) which makes possible easy removal from the mold. The amount of material to be used varies between 80 and 100 g, depending on the density of the composition. The mold is closed and placed in an automatic laboratory press preheated to 120° C. After waiting for the temperature of the assembly to stabilize at 120° C., an automatic molding cycle is started which comprises the following stages:
melting and forming the material at 120° C. under a mold clamping force of 200 bar for 5 minutes
raising the temperature from 120° C. to 190° C. with a gradient of 5° C./min, under a pressure of 200 bar
crosslinking the material at 190° C. for 20 minutes under a pressure of 200 bar
cooling the heating plates and the mold with a gradient of 15° C./min to a final temperature of 30° C. under a pressure of 200 bar
opening the press.

In a first, step, the molded plaques, which are separated from the polyester films, are removed from the mold. Subsequently, the plaques are allowed to degas at ambient temperature for 5 days. During the degassing, the plaques are maintained under a slight pressure in order to prevent any deformation of the plaques during these 5 days.

In a second step, the molded plaques are placed completely flat in a hot air oven preheated to 130° C. and are maintained under a slight pressure in order to prevent deformations. The heat treatment at this temperature is maintained for 60 minutes after stabilization of the temperature. Subsequently, the molded plaques are removed from the oven in order to allow them to cool to ambient temperature over 24 hours while retaining the slight pressure on the plaques in order to prevent deformations. The molded plaques are subsequently transferred into a room for precision measuring maintained at 20° C., where they are stored for at least 3 hours. The “width” and “depth” dimensions are measured using a digital sliding caliper. The retraction is calculated by comparing the dimensions (the width and the depth) of the impression of the mold with the width and the depth measured for each molded plaque. The retraction is expressed as a percentage.

The results obtained in the retraction test for the semiconducting compositions EB6 and EB8, and also two other semiconducting compositions R2 and R3 comprising a carbon black having properties which are not in accordance with those claimed in the present invention, are summarized in table 5 below. The particulars of compositions R2 and R3 are mentioned in table 6 below.

TABLE 5

| | Degree of retraction |
|---|---|
| Semiconducting | after 60 min/130° C. |
| composition | (%) |
| R2 | 7.42 |
| R3 | 6.72 |
| EB6 | 6.29 |
| EB8 | 6.33 |

TABLE 6

| | |
|---|---|
| R2 | Semiconducting composition comprising 86.6% by |
| | weight of a blend of 90 parts by weight of LDPE |
| | 2101TN00 and 10 parts by weight of Exact 8203, |
| | 13% by weight of Ketjenblack EC300-J and 0.4% |
| | by weight of Irganox 1081 |
| R3 | Semiconducting composition comprising 86.6% by |
| | weight of a blend of 60 parts by weight of LDPE |
| | 2101TN00 and 40 parts by weight of Exact 8203, |
| | 13% by weight of Ketjenblack EC300-J and 0.4% |
| | by weight of Irganox 1081 |

In table 6 above:
“LDPE 2101TN00” is a commercial reference of Sabic Europe B.V. for a low density ethylene homopolymer obtained by a polymerization process in a tubular reactor at high pressure, the density of which is 0.920 g/cm³ and the MFI of which is 0.85 g/10 min;
“Ketjenblack EC300-J” is a commercial reference of AkzoNobel Functional Chemicals B.V. for an “electroconductive” carbon black having a BET specific surface according to standard ASTM D 6556 of 800 m²/g and an oil absorption according to standard ASTM D 2414-90 of 310 ml/100 g; and
“Irganox 1081” is a commercial reference for a thiophenolic antioxidant of the 2,2′-thiobis(6-(t-butyl)-4-methylphenol) type, sold by Ciba Specialty Chemicals Inc.

All of the constituents of the compositions R2 and R3 referenced in table 6 are respectively metered into and mixed in a continuous mixer of Buss co-kneader type, twin-screw extruder type or another type of mixer appropriate for filler-comprising thermoplastic mixtures. The mixture is subsequently extruded in the form of rods and then cooled and dried in order to be formed into granules. These granules are then impregnated with a liquid organic peroxide, the content of which is adjusted according to the amount of polymer matrix to be crosslinked.

According to table 5, it is observed that, after the heat treatment, the compositions of the invention EB6 and EB8 show the smallest degrees of retraction, whereas the compositions R2 and R3 show particularly high degrees of retraction. This is because these two compositions use a carbon black for which:
the BET specific surface according to standard ASTM D 3037 is greater than 500 m²/g, and
the oil absorption value according to standard ASTM D 2414-90 is greater than 200 ml/100 g.

1. Electric cable comprising;
an electrical conductor;
a first semiconducting layer surrounding the electrical conductor;
an electrically insulating layer, obtained from an electrically insulating composition, surrounding the first semiconducting layer; and
a second semiconducting layer surrounding the electrically insulating layer,
wherein at least one of the semiconducting layers is obtained from a semiconducting composition comprising an ethylene homopolymer, a nonpolar ethylene copolymer and a semiconducting filler in an amount sufficient to render the composition semiconducting, the semiconducting filler having the following properties:
a BET specific surface according to standard ASTM D 6556 which is strictly less than 500 m²/g and preferably strictly less than 350 m²/g, and
an oil absorption value according to standard ASTM D 2414-90 which is strictly less than 200 ml/100 g and preferably strictly less than 174 ml/100 g.

2. Cable according to claim 1, wherein the first and second semiconducting layers are obtained from said semiconducting composition.

3. Cable according to claim 1, wherein the ethylene homopolymer selected from the group consisting of a low density polyethylene (LDPE), a linear low density polyethylene (LLDPE), a very low density polyethylene (VLDPE), and one of their blends.

4. Cable according to claim 1, wherein the nonpolar ethylene copolymer is a metallocene copolymer.

5. Cable according to claim 1, wherein the semiconducting composition comprises at least 50 parts by weight of ethylene homopolymer and 100 parts of polymer(s) in said composition and preferably at least 70 parts by weight of ethylene homopolymer per 100 parts of polymer(s) in said composition.

6. Cable according to claim 1, wherein the semiconducting composition comprises at least 15 parts by weight of nonpolar ethylene copolymer per 100 parts by weight of polymer(s) in said composition and preferably at least 25 parts by weight of nonpolar ethylene copolymer per 100 parts by weight of polymer(s) in said composition.

7. Cable according to claim 1, wherein the ratio of the percentage by weight of ethylene homopolymer to the percentage by weight of nonpolar ethylene copolymer in the semiconducting composition is greater than 1.

8. Cable according to claim 1, wherein the electrically insulating composition comprises at least 50 parts by weight of ethylene homopolymer per 100 parts by weight of polymer(s) in said composition.

9. Cable according to claim 1, wherein the electrically insulating composition does not comprise a compound which limits water trees.

10. Cable according to claim 9, wherein the electrically insulating composition comprises an ethylene homopolymer as sole polymer in said composition.

11. Cable according to claim 1, wherein the semiconducting composition and/or the electrically insulating composition additionally comprises an antioxidant.

12. Cable according to claim 1, wherein at least one of the layers chosen from the first semiconducting layer (3), the electrically insulating layer (4) and the second semiconducting layer (5) is an extruded layer, preferably two of these three layers are extruded layers and more preferably still these three layers are extruded layers.

13. Cable according to claim 1, wherein at least one of the layers chosen from the first semiconducting layer (3), the electrically insulating layer (4) and the second semiconducting layer (5) is a crosslinked layer, preferably two of these three layers are crosslinked layers and more preferably still these three layers are crosslinked layers.

14. Cable according to claim 13, wherein the semiconducting composition and/or the electrically insulating composition additionally comprises a crosslinking agent of the organic peroxide type.

15. Cable according to claim 1, wherein said cable additionally comprises a metallic shield surrounding the second semiconducting layer.

16. Cable according to claim 1, wherein additionally comprises a protective sheath surrounding the second semiconducting layer.

17. Cable according to claim 1,
wherein the first semiconducting layer, the electrically insulating layer and the second semiconducting layer constitute a three-layer insulation.

18. Cable according to claim 1, wherein the semiconducting filler is chosen from carbon blacks and graphites, or one of their mixtures.

19. Cable according to claim 1, wherein said BET specific surface according to standard ASTM D 6556 is strictly less than 350 m²/g.

20. Cable according to claim 1, wherein said oil absorption value according to standard ASTM D 2414-90 is strictly less than 174 ml/100 g.

21. Cable according to claim 5, wherein said semiconducting composition comprises at least 70 parts by weight of ethylene homopolymer and 100 parts of polymer(s) in said composition.

22. Cable according to claim 6, wherein said semiconducting composition comprises at least 25 parts by weight of nonpolar ethylene copolymer per 100 parts by weight of polymer(s) in said composition.

23. Cable according to claim 12, wherein at least two of the layers chosen from the first semiconducting layer (3), the electrically insulating layer (4) and the second semiconducting layer (5) are extruded layers.

24. Cable according to claim 12, wherein all three of the layers of the first semiconducting layer (3), the electrically insulating layer (4) and the second semiconducting layer (5) are extruded layers.

25. Cable according to claim 13, wherein at least two of the layers chosen from the first semiconducting layer (3), the electrically insulating layer (4) and the second semiconducting layer (5) are crosslinked layers.

26. Cable according to claim 13, wherein all three of the layers of the first semiconducting layer (3), the electrically insulating layer (4) and the second semiconducting layer (5) are crosslinked layers.
